(19) United States
(12) Patent Application Publication
(10) Pub. No.: US 2016/0077000 A1
(43) Pub. Date: Mar. 17, 2016

(54) REFRACTIVE INDEX BASED MEASUREMENTS

(71) Applicant: TECHNICAL UNIVERSITY OF DENMARK, Kgs. Lyngby (DK)

(72) Inventors: Henrik Schiøtt SØRENSEN, Ølstykke (DK); Thomas Martini JØRGENSEN, Jyllinge (DK)

(73) Assignee: TECHNICAL UNIVERSITY OF DENMARK, Kgs. Lyngby (DK)

(21) Appl. No.: 14/888,396

(22) PCT Filed: Mar. 18, 2014
(86) PCT No.: PCT/EP2014/055441

§ 371 Date: Oct. 30, 2015

(30) Foreign Application Priority Data
Mar. 21, 2013 (EP) 13160469.6

(51) Int. Cl. G01N 21/45

(52) U.S. Cl. CPC G01N 21/45

(57) ABSTRACT

In a method for performing a refractive index based measurement of a property of a fluid such as chemical composition or temperature by observing an apparent angular shift in an interference fringe pattern produced by back or forward scattering interferometry, ambiguities in the measurement caused by the apparent shift being consistent with one of a number of numerical possibilities for the real shift which differ by 2n are resolved by combining measurements performed on the same sample using light paths therethrough of differing lengths.

The present invention relates to methods and apparatus for making refractive index (RI) based measurements by interferometry.

U.S. Pat. No. 4,447,153 discloses a method for the measurement of small differences in optical absorptivity of weakly absorbing solutions using differential interferometry. Two sample cells are placed each in a respective arm of an interferometer and are traversed by collinear probe and heating laser beams and a reference beam. Respective sets of interference fringes are formed between the probe beams of the two cells and between the reference beams of the two cells. A differential response between the two cells upon heating is obtained by providing a different solute concentration in the two cells.

WO2004/023115 and US2006/0012800 disclosed a method of determination of refractive index using micro interferometric back scatter detection (MIBD) also known as back scatter interferometry (BSI) in which light from a laser was directed onto a capillary tube containing a sample liquid and the angular dependence of interference fringes produced by back scattering from the several optical interfaces involved was analysed. In particular, a critical angle was observed at which total internal reflection within the capillary wall caused the intensity of the fringes to drop sharply. An absolute value for the refractive index could be determined.

US 2002/0135772 and Bornhop et al; Science 21 Sep. 2007; Vol. 317 describe a method of conducting MIBD using a laser beam directed onto a rectangular cross section channel in a microfluidic chip. Interference fringes were produced which had a position which was dependent on the refractive index of the liquid in the channel, and changes in the refractive index (e.g. upon chemical binding) were seen as a shift in the fringe pattern, so providing a relative measure of the refractive index. Thus, changes in refractive index in the sample can be monitored by observing the movement of fringes in the pattern over time.

In these latter systems, unlike in U.S. Pat. No. 4,447,153, interference is produced between light scattered from interfaces between solid and liquid. Hence, an interference pattern is observable from a single sample cell, whereas in U.S. Pat. No. 4,447,153, two cells are needed.

Whilst the above latter disclosures relate to obtaining refractive index based information from interference fringes produced by backscattered light, U.S. Pat. No. 5,251,009 describes a related method in which forward scattered light produces the interference. Laser light is directed onto a fluid filled capillary and scattering occurs at interfaces formed by the capillary and its contents. A detector is provided off the axis of the laser beam, but on the other side of the capillary from the laser to view forward scattered light. Because there will be contributions from the exterior of the capillary acting as an interface which are considered an undesirable complicating factor in the interference pattern, steps are described for subduing such contributions. These involve enclosing the capillary in a fluid filled rectangular box and matching the refractive index of the fluid in the box with that of the glass or other material of the capillary wall. It was desired that the only interfaces contributing to the interference pattern would be those between the interior wall surface of the capillary and its contents.

In these systems, changes in a property of the fluid that change its refractive index can be monitored as a change in the phase of the interference pattern. Each fringe shifts position to an extent and in a direction determined by the change in refractive index. However, it has been a problem in such systems that if each fringe moves far enough it comes to occupy a position previously occupied by an adjacent fringe and the original pattern is substantially repeated. This corresponds to a change in phase of the pattern by 2π or a multiple of 2π.

This introduces an ambiguity into the measured refractive index change and the change in the underlying property of the fluid.

We have now appreciated that the sensitivity of such measurements depends on the path length of the light through the fluid generating the interference pattern. The fringes will move further for a given change, and the phase change will be greater, if the path length is greater. By comparing the phase changes generated when at least two different path lengths are used, it is possible to remove the ambiguity in the measured refractive index change by using a less sensitive measurement to determine whether a more sensitive measurement has exceeded a phase change of 2π. This enables us to extend the dynamic range of the measurement whilst maintaining sensitivity.

As disclosed in a co-pending European Patent Application No. 13160346.6 filed 21 Mar. 2013 by the same applicant entitled ‘Refractive Index Based Measurements’, a further problem in this type of measurement arises from a variability in the spacing of interference fringes produced in these systems.

As is seen in FIG. 3 of US2006/0012800, the spacing between the dark and light fringes of the interference pattern produced by BSI is not uniform but changes with distance from the centre of the pattern, i.e. the spatial frequency of the fringe pattern is chirped. The same will apply to fringe patterns generated by forward scattering of the kind dealt with in U.S. Pat. No. 5,251,009.

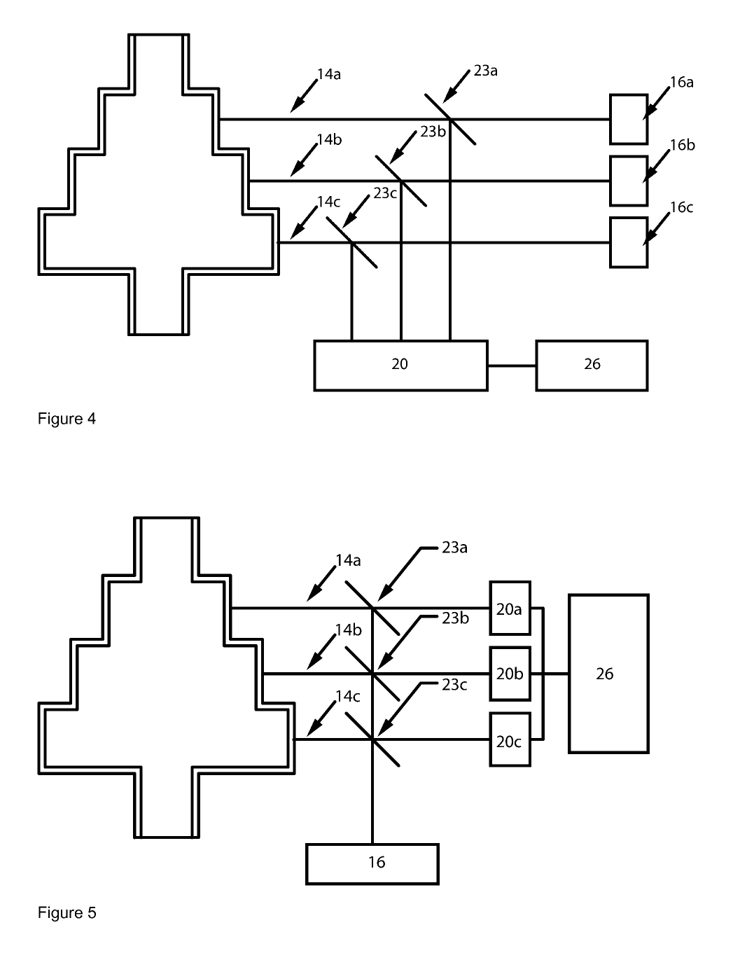

As one moves away from the angle of illumination, the fringes become closer together. The rate of change of spacing with angular distance however falls as one moves to greater angles, so the pattern of brightness/intensity becomes more sinusoidal. As seen in FIG. 4 of US2006/0012800 there is a good deal of fine intensity structure within these medium frequency fringes. When the refractive index of the sample changes, the position of each fringe shifts. A consequence of the spatial chirping of these fringes is that when the refractive index changes and the fringes move, they do not all move at a uniform speed. This is noted by S. S. Dotson in a Dissertation submitted to Vanderbilt University in 2008.

Dotson discloses that if a linear CCD array and a fast Fourier transform (FFT) are used to acquire a fringe pattern, one can determine the positional shift with change in RI. Selecting a slice of pixels from a region of the pattern where the fringe pattern is approximately sinusoidal is necessary because the method is dependent on a constant frequency over the angular region being used. A detection limit of 7×10⁻⁸ RI units (RIU) is said to be possible. Dotson also teaches the use of a cross-correlation technique as an alternative to FFT for analysing the fringe pattern as a means of avoiding being limited to an apparently sinusoidal region of the pattern. Dotson remarks that the fringes in the more sinusoidal area of the pattern do not move so much with changes in RI as fringes nearer the centre of the pattern and this limits the sensitivity.

We have found that if the fringe pattern is subjected to a mathematical or optical manipulation to remove or reduce the chirp in its spatial frequency and hence to make the speed of movement of the different fringes with RI change more uniform, more of the information content of the fringe pattern can be used and improved accuracy can be obtained in RI based measurements derived from the fringe pattern. Increased robustness and sensitivity is also obtained by avoiding the ambiguity of what frequency to pick from a chirped pattern.

Such a de-chirping can also be used in the context of the present invention.

An alternative approach to dealing with the chirp described above is set out in a co-pending European Patent Application No. 13160344.1 filed on 21 Mar. 2013 by the same applicant entitled ‘Refractive Index Based Measurements’. According to this approach, instead of observing over a range of output angles the spatial positions of fringes produced using a single wavelength of input light, one instead observes how the intensity of light at a chosen angle of observation varies when the wavelength of the input light is varied. It is possible this way to observe a more sinusoidal variation and to avoid the complications in data analysis resulting from the above mentioned spatial chirp. This method may also be used in the practice of the present invention.

Accordingly, the invention provides a method of refractive index based measurement of a property of a fluid comprising

directing coherent light along a plurality of input light paths within an apparatus,

for each input light path, producing scattering of said light from each of a plurality of interfaces within said apparatus including interfaces between said fluid and a surface bounding said fluid, said scattering producing an interference pattern formed by said scattered light,

each said input light path having a path length through said fluid such that there are at least two different said path lengths and at least two different interference patterns are formed, each having a respective phase,

recording each said different interference pattern,

changing a refractive index determining property of said fluid and thereby changing the phase of each said interference pattern,

calculating said change of property from said changes of phase which uniquely is consistent with each said change of phase. This may be performed by a method that includes determining whether any of said changes of phase exceeds 2π and, if so, by how much.

Preferably, light is directed along three input light paths, each having a different path length through the fluid, so producing three different interference patterns, and said calculation is based on the phases of the three interference patterns. However, two or more than three different path lengths may also be used.

Preferably, the change of said property is calculated from said changes of phase by calculating an apparent phase change of less than 2π radians between starting and changed patterns for each input path length; calculating at least two provisional values for a change in a refractive index determined property consistent with the apparent phase change observed for a first of said input path lengths, allowing that the true phase change may be greater than 2π, determining which of the determined provisional values of the change in the property is consistent with the apparent phase change calculated for a second, shorter light input path length; and choosing that consistent provisional value as the true changed value of the change in the property. Optionally one may go on to determine which of the determined provisional values of the change in the property is consistent with the apparent phase change calculated for a third or still further light input path length, followed by choosing that consistent provisional value as the true changed value of the change in the property.

Optionally, the change of said property is calculated from said changes of phase by

determining an integer value N such that:
(N*2π+Δφ₂)/s_{higher}−Δφ₁/s_{lowest} is minimized, where Δφ₁ denotes the observed phase change produced by the shortest of the light paths, Δφ₂ denotes the observed phase change corresponding to a longer one of said light paths, S for each light path is the sensitivity of the measurement for that light path dφ/dn, so that s_{lowest}=(dφ/dn)_{lowest}, and s_{higher}=(dφ/dn)_{higher}, and forming a revised estimate of the actual phase change for the longer light path according to the formula N*2π+Δφ₂.
   Optionally, for each light path length
a varying intensity of light in said pattern is detected in a spatially extending detector crossing the pattern,
said detected intensity of light for each light path comprises alternating light and dark fringes spaced one from another on at least one side of a centroid position, and in the interference pattern, optionally after mathematical transformation, a figure of merit (M) measured over n fringes contained within the first 15 fringes starting from the centroid position is not greater than 0.005, where n is 10,
M being calculated according to the formula:

M=standard deviation of fringe spacing/(mean spacing of fringes*number of fringes(n)).

Optionally,
for each input light path there is produced an interference pattern formed by said scattered light and for each light path varying intensity of light in said pattern is recorded in a spatially extending detector crossing fringes of said interference pattern,
said recorded varying intensity of light in said pattern is mathematically transformed to reduce or remove a chirp in a local spatial frequency of fringes exhibited by said pattern at the detector and thereby a modified intensity variation is produced and said calculation of the change of property is performed based on the phase changes of said modified intensity variations.

Optionally, said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).

Optionally, said mathematically transforming step is conducted by applying a coordinate transformation to said recorded varying intensity of light along the detector.

Optionally, for this purpose, a frequency spectrum is obtained for the spatial frequencies of the fringes in said recorded intensity, a maximum peak amplitude value of said frequency spectrum is determined, a first offset value (x_{offset}) is chosen by which to transform a coordinate (x) of intensity values in said recorded varying intensity of light along the detector and said coordinate transformation is carried out using said first offset value, the frequency spectrum and the peak amplitude value thereof are obtained again and compared with their previous values and the process is repeated using different offset values to obtain a value of the offset value that increases the maximum peak amplitude value.

Preferably, the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.

Optionally in this procedure, a frequency spectrum is obtained for the spatial frequencies of the fringes of said recorded intensity, the arrangement of the detector and any optics intervening between the detector and the said interfaces is adjusted, the frequency spectrum and the peak amplitude value thereof are obtained again and compared with their previous values and the process is repeated to obtain a said arrangement that increases the maximum peak amplitude value. Preferably, an offset value is selected that provides the maximum value obtained for the maximum peak amplitude value.

Typically, the adjustment of said arrangement of the detector and any optics intervening between the detector and the said interfaces is a rotation of the detector or a rotation of a reflective optical component intervening between the detector and said interfaces.

Optionally, as an alternative method of avoiding said chirp, the method of the invention is one further comprising for each input light path obtaining the respective interference patterns by varying the wavelength of said light in said input light path and recording variation of intensity of the interfering light with change in wavelength of the light at an angle of observation. Alternatively, one could provide broadband light in each input light path and sweep the output of a spectrometer separating the wavelengths of scattered light over a detector provided at an angle of observation within the interference pattern so produced.

Preferably, in such a case, said varying of the wavelength of said light in each light input path sweeps the wavelength of the light over a range of wavelengths, which range is from 1 nm to 20 nm wide. The varying of the wavelength of the light is preferably repeated cyclically, suitably at a rate of from 10 Hz to 50 KHz.

The method may be carried out using an apparatus which includes a flow path for the supply of a fluid to a location where the fluid meets the input light paths and a flow path for removal of said fluid from said location.

Suitably, said apparatus includes a flow path for the supply of a fluid to a location where the fluid meets the input light paths and a flow path for removal of said fluid from said location.

The method may be one further comprising the step of driving a flow of fluid through said location.

The method may be one further comprising operating a temperature control means to maintain said fluid at a desired constant or varying temperature.

Whilst the methods of the invention may be applied to forward scattered light, preferably each interference pattern is detected at a position where it is formed by backscattered light.

In a further aspect, the invention includes apparatus for use in performing a refractive index based measurement of a change in a property of a fluid, by a method comprising directing coherent light along input light paths within said apparatus, producing scattering of said light from each of a plurality of interfaces within said apparatus including interfaces between said fluid and a surface bounding said fluid, and for each input light path detecting properties of an interference pattern formed by said scattered light,

wherein said apparatus comprises
at least one source of coherent light for directing light along at least two said input light paths,
a cavity in each input light path for containing said fluid in use and defining said plurality of interfaces, each cavity defining a path length in said fluid for light in a respective said input light path, such that the path lengths defined by the respective cavities differ from one another,
at least one detector positioned to sense light forming at least two said interference patterns of fringes produced by scattering from said interfaces in respective ones of said at least two input light paths in use, said detector producing in use an electronic output in response thereto which provides a recording of varying intensity of light in each of said interference patterns, and
computation means for extracting from a shift in position of fringes in each of said at least two interference fringe patterns a calculated change in said property which uniquely is consistent with the shift measured in each said interference fringe pattern.

Preferably, said cavities for containing said fluid are portions of a tube, said portions having differing respective dimensions in a transverse direction along which said light passes in use. Preferably, said tube is a stepped diameter circular cross sectioned tube. However, other cross sections may be employed. In particular, the transverse dimension of each cavity in the direction of input light propagation may be greater than in a direction orthogonal thereto so as to achieve a greater light path for a given volume of fluid on which to make the measurements. Cavities may alternatively be connected for parallel rather than sequential flow of the fluid.

Optionally, the apparatus may be one comprising at least two said coherent light sources, each said light source being arranged to direct light along a respective one of said light input paths. Alternatively, the apparatus may be one comprising one coherent light source and at least one optical component for splitting the light output of said source to pass along multiple said light input paths. In this way, one light source can operate on multiple ones of said cavities.

Just as one may use one or several light sources, so one may use one or several detectors. Thus, the apparatus may be one comprising a respective said detector for sensing light forming each of said interference fringe patterns. Alternatively, it may be one in which one detector receives the multiple interference patterns.

In order to minimise the number of different cavity dimensions required to deduce unambiguously the change in value of the measured property, the path lengths defined by the respective cavities may differ from one another by a factor of other than 2.

An apparatus of the invention may be one comprising three said cavities defining different respective path lengths, such that the largest path length differs from the middle path length by a factor different from the factor by which the middle path length differs from the smallest path length.

Optionally, said computation means is pre-programmed to remove or reduce a chirp exhibited by a spatial frequency of fringes in each said interference fringe pattern by a method comprising mathematically transforming a recorded varying intensity of light in said pattern to reduce or remove said chirp prior to extracting said change of property.

Optionally, the or each coherent light source is a variable wavelength coherent light source, and the apparatus further comprises a wavelength controller operable for varying the wavelength of said light in each said input light path so as to produce a variation at an angle of observation of intensity of detected interfering light with change in wavelength of the light, and the computation apparatus is programmed for calculating said fringe position shift from said variation for each cavity prior to extracting said change of property.

Suitably, each said cavity has a transverse dimension in the direction of its input light path of from 1 μm to 10 mm, for instance from 0.5 to 3 mm.

Optionally, said apparatus includes a flow path for the supply of a fluid to an upstream one of said cavities and a flow path for removal of said fluid from a downstream one of said cavities which is in fluid communication with said upstream cavity.

The apparatus may include means for driving a flow of fluid through said cavities. Fluids may be driven through the cavity or cavities of the apparatus where desired by the action of a suitable fluid flow driving means, which may be a pump, such as a syringe pump or peristaltic pump, or may be passive capillary forces, or may be means for producing electro-osmotic flow by the application of voltage.

The apparatus may include a temperature control for maintaining said fluid at a desired constant or variable temperature. This may be a Peltier or other temperature control device and preferably includes a temperature sensor operatively connected to a device for heating and/or for cooling said sample.

Optionally, two similar sets of cavities are provided in close proximity and each is similarly illuminated by a respective or common light source or set of light sources to provide a similar interference patterns such that one set of cavities may operate as a reference channel for the other. Thus, for instance, if the fluid in one set of cavities is kept constant in nature and the fluid in the other chamber is allowed to vary, the variations may be isolated from the effects of factors influencing both chambers such as temperature change. P Computation of the desired measurement from the interference fringe patterns may be by FFT, cross-correlation, pattern recognition or other such known methods.

All of the apparatus features described above in connection with the method of the invention may be used in such apparatus and vice versa.

References to refractive index determination herein should be understood where the context permits to include absolute refractive index measurement and also relative refractive index measurements (i.e. measurements of the difference between the refractive index of one material and that of another, or temporal changes in refractive index of one material). Refractive index measurements need not be expressed in refractive index numbers but may be translated into some other quantity which affects refractive index such as sample temperature or solute concentration. Thus, through their effect on refractive index one can measure temperature, pressure, concentration and molecular interactions, thereby obtaining thermodynamic and kinetic information for specific types of molecules which may include cytokines, hormones, immunoglobulins, C-Reactive Protein, enzymatic reactions and troponin, as well as polynucleotides by way of example.

The invention will be further described with reference to and as illustrated in the accompanying drawings, in which:

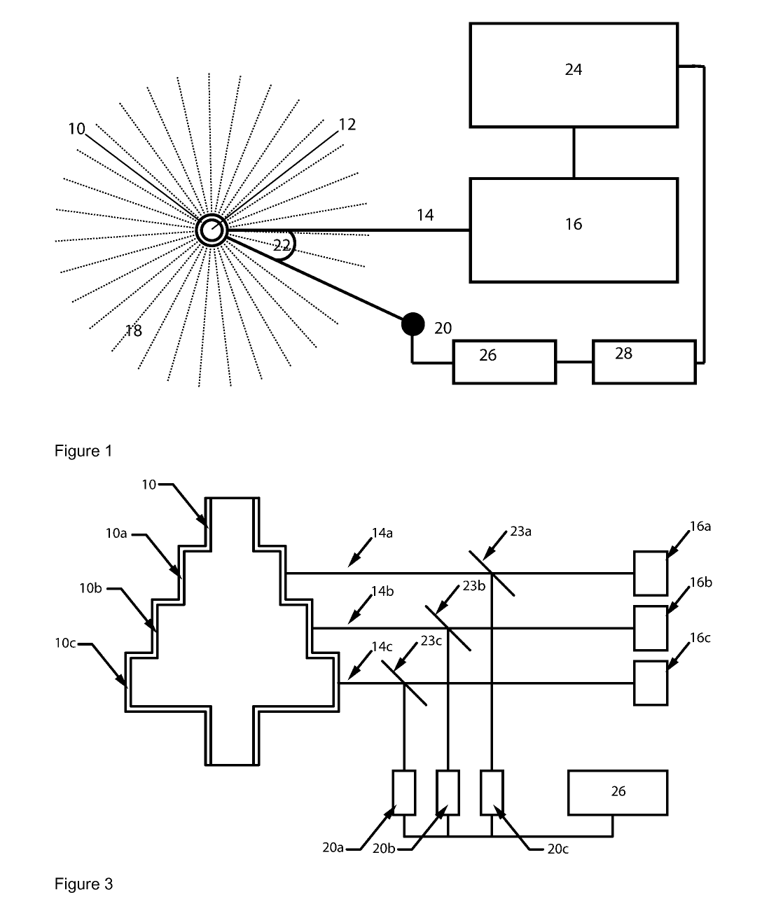

FIG. 1 shows a schematic arrangement seen from above of apparatus according to the invention for performing an MIBD or BSI refractive index determination;

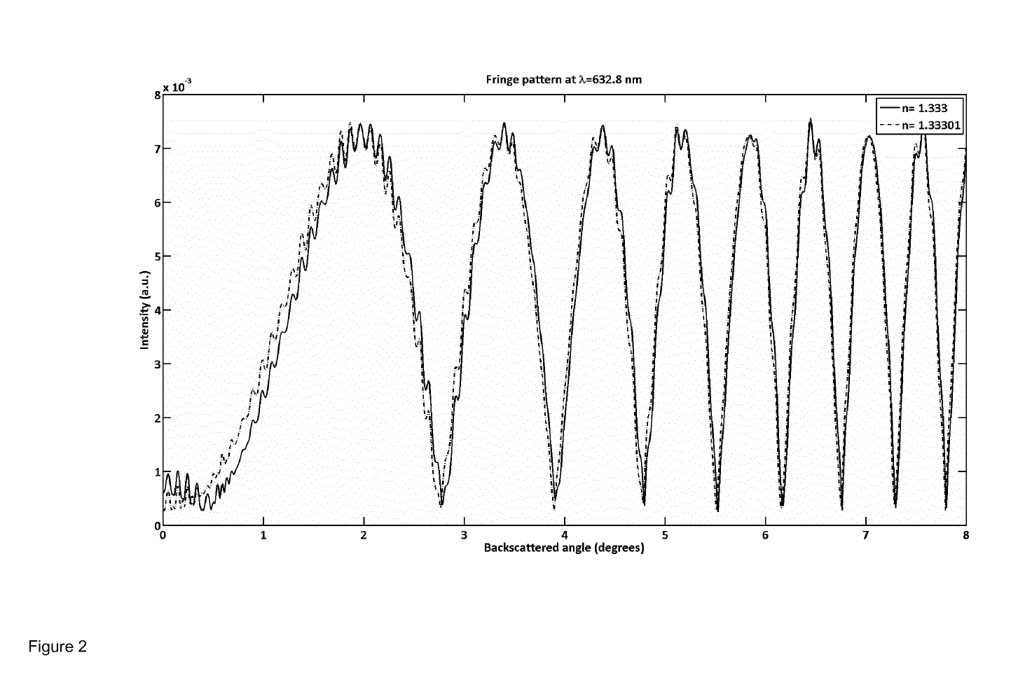

FIG. 2 shows an example of a first interference pattern experimentally observed using the apparatus of FIG. 1;

FIG. 3 shows the apparatus of FIG. 1, viewed from the side;

FIG. 4 shows a first variant of the apparatus of FIG. 1, viewed from the side;

FIG. 5 shows a second variant of the apparatus of FIG. 1, viewed from the side;

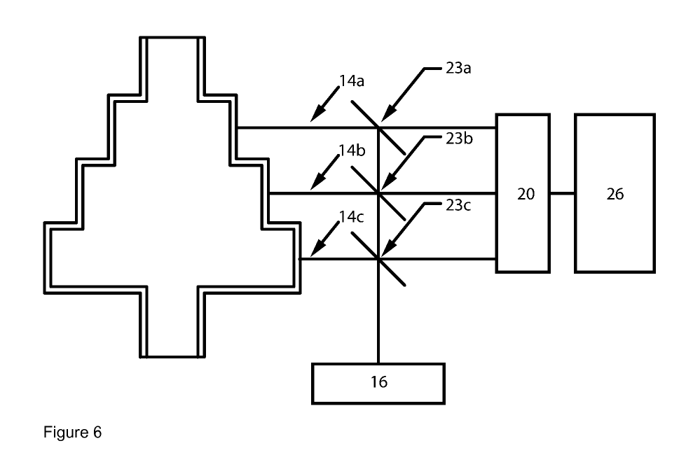

FIG. 6 shows a third variant of the apparatus of FIG. 1, viewed from the side;

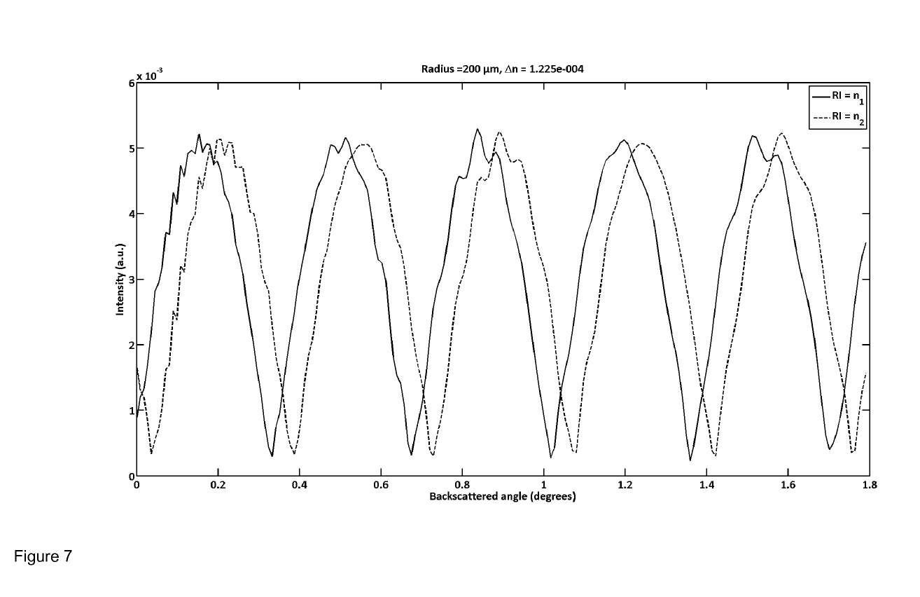

FIG. 7 shows a dechirped interference pattern originating from portion 10a of the apparatus of any one of FIGS. 3 to 6;

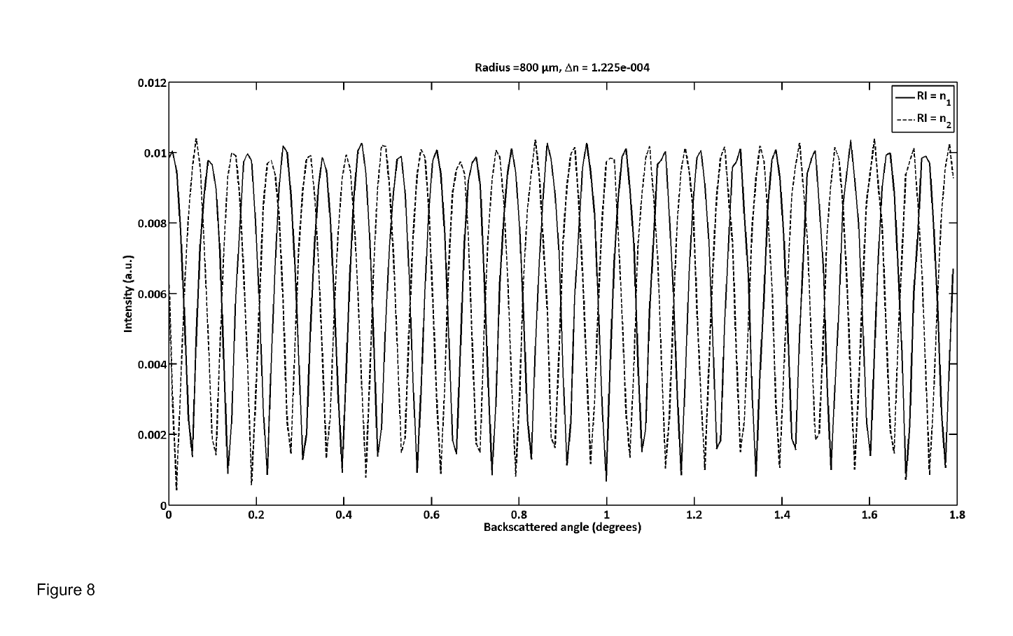

FIG. 8 shows a dechirped interference pattern originating from portion 10c of the apparatus of any one of FIGS. 3 to 6;

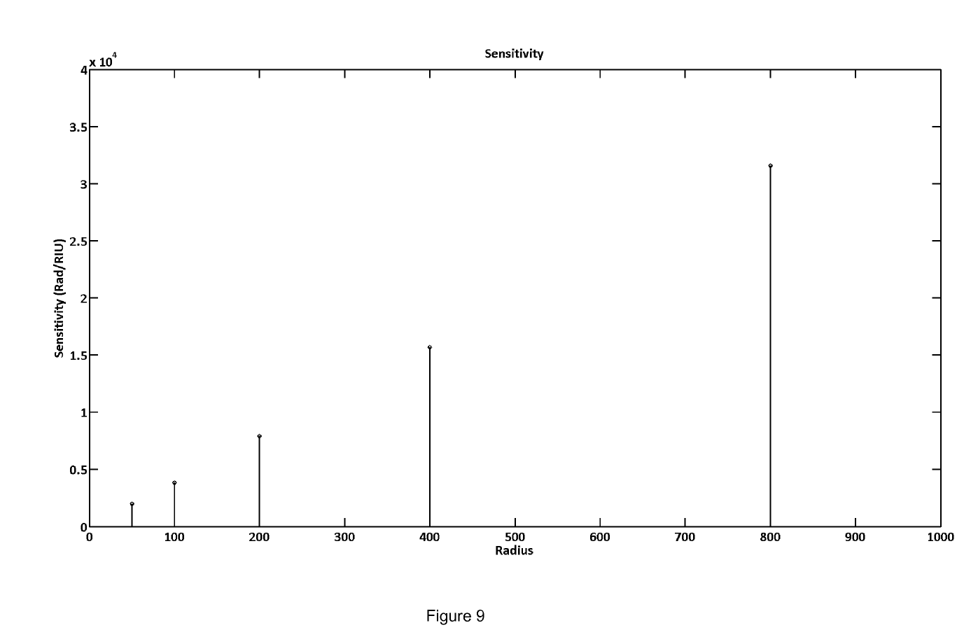

FIG. 9 is a graph showing the sensitivity of BSI refractive index measurements plotted against the input light path length through the medium (here taken as the diameter of a sample tube);

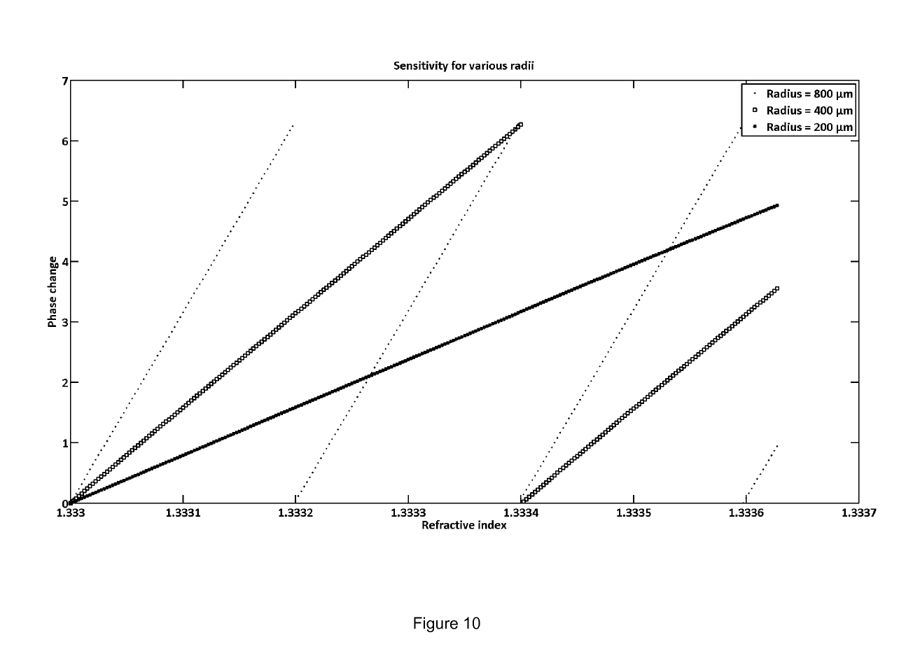

FIG. 10 is a graph showing a typical result of plotting observed phase change in radians against RI values increasing from a base value of 1.3330 for each of three input light path lengths;

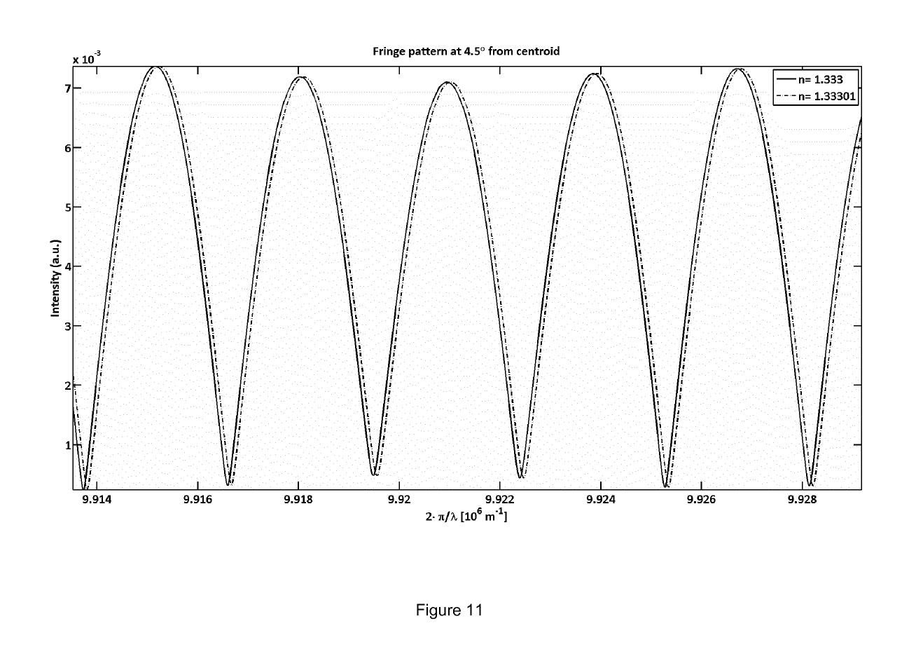

FIG. 11 shows a plot of an interference pattern in k-space obtained at one path length;

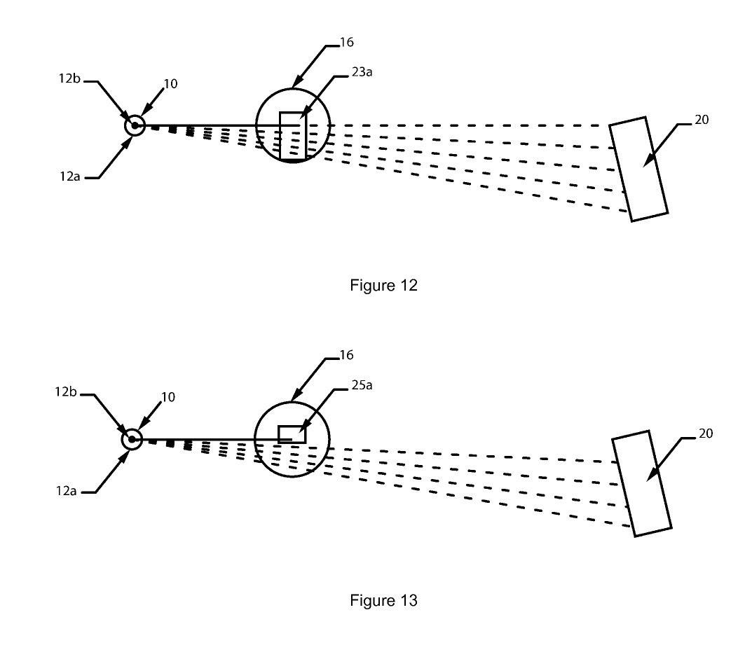

FIG. 12 shows a view of apparatus of the invention generally as per FIG. 6 seen from above; and

FIG. 13 shows a modified apparatus of the kind shown in FIG. 12.

FIG. 1 illustrates the principles of MIBD or BSI, but also illustrates the invention. A laser 16 (or multiple lasers) directs a beam along a light input path 14 towards a stepped diameter sample tube 10 having a bore of changing diameter 12 containing a sample liquid. Light 18 is scattered from interfaces between air and the tube wall material, and between the wall material and the liquid, over a range of angles 22. When viewed from an observation point on the same side of the tube as the laser at a CCD array 20 covering part of a range of angles 22, or a CMOS array, or other spatially extending detector the backscattered light forms interference fringes as seen in FIG. 2, and these can be recorded in a computer 26 for analysis. If this were an FSI arrangement, the detector array would suitably be in a position diametrically across the tube 10 from where it is in the figure. The detector array may be within a camera pointed at the tube at a selected angle to the laser light beam.

The plot of the intensity of the pattern against the angle 22 from the axis of the illuminating beam from any one of the steps in the diameter of the tube will be generally as in the simulation shown in FIG. 2. In contrast to what is seen in U.S. Pat. No. 4,447,153, here each diameter step in the tube provides its own respective interference pattern and each diameter step portion contains the same sample at any given time.

It can be seen that the fringes become more closely spaced as one moves away from the axis (0 position). Less obvious to visual inspection is that the rate of change of spacing decreases so that the spacing is more uniform at high values on the abscissa scale.

As seen in FIG. 3, the tube 10 has three stepped diameter portions 10a, 10b and 10c. Three respective lasers 16a, 16b and 16c are directed to send light along light input paths 14a, 14b and 14c to respective portions of the tube 10. Each input light path passes through a respective beam splitter 23a, 23b, or 23c.

Light scattered from the front and back interfaces between the tube and the liquid at each of its different diameter sections is reflected by the respective beam splitter towards a respective detector 20a, 20b and 20c, each of which may be either a spatially extending detector capturing the position of interference fringes of the kind shown in FIG. 2 or else may be a single point detector capturing a change in intensity of the scattered light as the wavelength in the light input path is modulated, as described in European Patent Application No. 13160344.1. As illustrated, each detector is a CCD chip providing a one dimensional array of recording pixels, but may be an alternative detecting device. Three such arrays of pixels are used for recording respective ones of the three interference fringes originating from the three different diameter portions of the sample tube 10. The detected fringe patterns are passed to a computer 26 for analysis.

Other arrangements can provide the same functionality. FIG. 4 shows an arrangement wherein there are three lasers 16a, 16b and 16c, but a combined single spatially extending detector 20 for recording at a two dimensional array of pixels divided into three parallel bands, providing three outputs for analysis, which feed the computer 26.

In FIG. 5 a single laser 16 is directed towards three beam splitters 23a, 23b and 23c, each of which directs the light over a respective light input path 14a, 14b and 14c. The output light is registered at three detectors 20a, 20b and 20c and their output is passed to computer 26.

In FIG. 6, a single laser 16 is used with a single detector 20 and three beam splitters 23a, 23b and 23c.

Supposing that the diameter of the portion 10a of the sample tube 10 is 200 μm, the interference fringe pattern recorded at the detector, after de-chirping as described in European Patent Application No. 13160346.6 would be as illustrated in FIG. 7 (solid line).

Supposing that the diameter of the portion 10c of the sample tube 10 is 800 μm, the interference fringe pattern recorded at the detector, after de-chirping as described in European Patent Application No. 13160346.6 would be as illustrated in FIG. 8 (solid line).

Supposing that the refractive index of the liquid now changes from an initial value n₁ to a new value n₂, new positions for the interference fringe patterns will be observed for each tube diameter, and these are illustrated by the dotted traces in FIGS. 7 and 8.

From both FIGS. 7 and 8 we observe apparent phase changes. We can however not see in either figure whether each fringe has actually moved by more than one fringe spacing. If a similar ambiguity in the amount of fringe movement arises in U.S. Pat. No. 4,447,153, nothing is done there to address it. However, in accordance with the present invention, the ambiguity is addressed and solved. If the sensitivity corresponding to FIG. 7 is arranged so that we know that we shall never move more than one fringe, we can combine this measurement with the one of FIG. 8 to calculate whether the signal in FIG. 8 has moved more than one fringe. In this illustration, the fringes in FIG. 8 have actually moved by more than one fringe spacing.

FIG. 9 shows how the sensitivity of BSI refractive index measurements depends on the path length through the fluid of the input light path. As can be seen, the sensitivity is approximately proportional to the path length.

It would be desirable to make use of this increased sensitivity by using the larger tube diameter, but then the change in refractive index becomes ambiguous because it is not possible to tell from this one measurement alone whether it is determined from the apparent shift in position of the peaks or whether it needs to be adjusted on the basis that the peaks have moved by more than the peak spacing.

Alternatively expressed, if the phase of the pattern appears to have shifted by a radians, one needs to determine whether the actual shift is a, or a+n·2π, where n is an integer (positive or negative).

The phase of a fringe pattern can be determined by Fourier-transform analysis. FIG. 10 shows how the apparent phase change varies with change in refractive index for three sample tube diameters, i.e. 200, 400 and 800 μm.

As can be seen, starting from a refractive index of 1.333, the phase change observed with the most sensitive diameter of 800 μm increases linearly with refractive index up to a value of 2π (6.28) at which point the phase change apparently returns to zero. This is the point at which the fringes have shifted so far that they have apparently repeated their initial positions. An observed phase shift of say 1 radian is therefore consistent with a refractive index change from 1.3330 to any of 1.333025, 1.333225 or 1.333425.

The ambiguity can be resolved by combining the results from the three tube diameter portions 10a to 10c as follows.

If one now looks at the plot of phase change against RI for the 800 μm diameter tube, suppose that the apparent phase change using the 800 μm diameter tube portion is seen to be one radian. The question is how to determine whether this is genuinely a phase change of one radian or whether it is really 1+2π radians or even 1+4π radians. One sees that the apparent phase change of 1 radian measured on the 800 μm diameter tube portion is consistent with seeing an apparent phase change of either about 0.5 radians or about 3.5 radians on the 400 μm tube portion and either about 0.2 radians or about 2 radians on the 200 μm tube portion. Furthermore, even a combination of apparent phase changes of 1 radian at 800 μm and of about 0.5 radians at 400 μm is consistent with two substantially different changes in RI (1.333025 or 1.333425). The observed apparent shift of 1 radian on the 800 μm diameter tube portion could therefore correspond to a refractive index change from 1.3330 to 1.333225, or 1.333425, but if 0.5 radians is measured on the 400 μm diameter portion, the correct value cannot be 1.333225. For a change to 1.333225, the 400 μm diameter portion would have given a reading of about 3.5 radians.

The remaining ambiguity can be eliminated by considering the results at 200 μm. If the true value of the changed refractive index is 1.333225, the value obtained for the phase change using the 200 μm diameter will be about 0.25 radians, whereas if the true value is 1.333425, the phase change using the 200 μm diameter will be about 3.25 radians.

One systematic procedure for this is as follows: measure a starting fringe pattern at a starting refractive index for each input path length; measure an altered fringe pattern at a changed refractive index for each input path length; calculate an apparent phase change of less than 2π radians between said starting and changed patterns for each input path length; calculate at least two provisional values for a change in a refractive index determined property consistent with the apparent phase change observed for a first of said input path lengths (allowing that the true phase change may be greater than 2 pi); determine which of the determined provisional values of the change in the property is consistent with the apparent phase change calculated for a second, shorter light input path length; choose that consistent provisional value as the true changed value of the change in the property.

An alternative procedure is as follows. The different channel sizes correspond to different sensitivities s=dφ/dn The channel with the lowest sensitivity s_{lowest}=(dφ/dn)_{lowest} determines the Maximum Dynamic Measurement Range:

Δnₘₐₓ=2π/(dφ/dn)_{lowest}.

Let the observed phase change corresponding to the lowest sensitivity be denoted Δφ₁.
Let the observed phase change corresponding to a channel size with higher sensitivity s_{higher}=(dφ/dn)_{higher} be denoted Δφ₂.
One must then determine the integer value N so that: ABS((N*2π+Δφ₂)/s_{higher}−Δφ₁/s_{lowest}) is minimized. The resulting value of N corresponds to the 2π cycles that must be unwrapped when using the channel size with the higher sensitivity. With the resulting N value one can now use (N*2π+Δφ₂)/s_{higher} as a more sensitive estimate of the refractive index change instead of Δφ₁/s_{lowest}. If more than two channel sizes and thereby more sensitivities exist one can unwrap any high sensitivity measurement by using a lower sensitivity measurement, assuming this latter measurement has itself been unwrapped by using a measurement with even lower sensitivity or itself supports the required dynamic range. By having more than two channel sizes available one can also check for consistency between the resulting unwrapped estimates of the refractive index changes. This can be useful for estimating the confidence in the performed measurement.

In this example, part of the ambiguity is arising from the fact that the ratio of the sensitivities between the two considered tube diameters is two, so that the first repeat of the pattern from the 400 μm tube portion starts at the same point on the RI scale as the second repeat from the 800 μm tube portion at 1.333400. It would therefore be preferable to avoid the ratio between the diameters of the tube portions (and hence the ratio between the sensitivities) being an integer and this will ensure that two diameter portions are sufficient to resolve ambiguities.

As mentioned above, the fringes in FIGS. 7 and 8 have been treated to remove the chirp seen in FIG. 2. A plot of the power spectrum of the intensities of the fringes in FIG. 2 would show a number of peaks of similar magnitude.

The intensity pattern seen in FIG. 2 can be modelled by the equation:

(x)≅D((x+x_{offset})²+θ)+E (I)

where I is the intensity, x describes the angular coordinate of observation and a, x_{offset}, D, E are constants and θ is a phase term, dependent on refractive index of the sample liquid.

In order to reduce the chirp, we aim to make a coordinate transformation:

t=(x+x_{offset})² (II)

to produce an unchirped fringe pattern:

(t)≅D(at+θ)+E (III)

To do this it is necessary to estimate an appropriate value to use for x_{offset}.

This problem may be solved as follows:

A range of x_{offset} is searched (in an intelligent way) to find the value of x_{offset} that maximizes to a given precision the maximum peak amplitude value (above the DC region) in the spatial frequency spectrum of the recorded fringe pattern by applying the variable transformation x->t.

With the estimated value of x_{offset} we remap the abscissa for the recorded fringe pattern. Interpolated values of the fringe pattern for coordinate values between the remapped x-values can eventually be estimated by interpolation/resampling.

The effect of this on the power spectrum is that as better values for x_{offset} are tried, so the maximum peak amplitude increases and the number of peaks having a substantial share of the power decreases.

The effect of this on the plotted fringe pattern itself can be appreciated by comparing FIG. 2 with FIGS. 7 and 8.

A consequence of this is that when the refractive index of the sample liquid changes and as a result the position of the fringes changes with all of the fringes stepping to the right or left, the speed of movement of the fringes becomes uniform also.

De-chirping the fringe patterns in this way improves the achievable sensitivity of the measurements of RI change.

The offset used above can be estimated and optimised in various ways other than that previously described. It is possible to estimate the offset by determining the angle between the camera position or a CCD array and the incoming laser beam. Also fitting the obtained fringe pattern to a formula D((x+x_{offset})+θ)+E can be used to estimate the offset.

For the better understanding of this aspect of the invention, one may consider a laser beam illuminating a circular cross section channel (chamber) containing a sample liquid. Part of the light is back-reflected from one or more interfaces between the chamber and the surrounding layer(s) —we denote this light reference light. Another part of the light is refracted into the chamber, then reflected within the chamber and refracted out of the chamber—this can be considered as light from the sample “arm”. At a given observation distance one then observes the angular interference pattern I(φ) between the reference light and the sample light.

Iₙ_{ₗ}(φ)=Aₙ_{ₗ}(φ)sin [Θₙ_{ₗ}(φ)]=Aₙ_{ₗ}(φ)sin [fₙ_{ₗ}(φ)φ+θₙ_{ₗ}(φ)]

Here A(φ), f(φ), and θ(φ) denotes the local amplitude, the local frequency and the local phase, respectively, of the angular interference pattern as functions of the angle φ. When the refractive index of the sample liquid is changing within the chamber the interference pattern will change. All of A(φ), f(φ), and θ(φ) will in general be affected.

In order to capture accurate information about the changes in refractive index n₁ of the liquid from observation of changes in the interference pattern, it is essential to understand how a change Δn in n₁ affect the interference pattern.

$$\begin{matrix}{I}_{{n}_{l} + Δ n} ( ϕ ) = {A}_{{n}_{l} + Δ n} ( ϕ ) sin [ {Θ}_{{n}_{l} + Δ n} ( ϕ ) ] \\ = {A}_{{n}_{l} + Δ n} ( ϕ ) sin [ {f}_{{n}_{l} + Δ n} ( ϕ ) ϕ + {θ}_{{n}_{l} + Δ n} ( ϕ ) ] \\ = {A}_{{n}_{l} + Δ n} ( ϕ ) sin [ ( {f}_{{n}_{l}} ( ϕ ) + Δ {f}_{Δ n} ( ϕ ) ) ϕ + {θ}_{{n}_{l}} ( ϕ ) + {θ}_{Δ n} ( ϕ ) ]\end{matrix}$$

We have used both mathematical modelling based on Maxwell Equations as well as ray tracing to obtain insight into how the fringe pattern behaves and especially how it changes in relation to varying the refractive index of the liquid in the channel.

We observe that for changes in n₁ of order 10⁻² for channels with a diameter in the region of 0.1 mm and above one will locally observe a phase change that is both due to change of frequency and due to a changed optical path length difference of the interfering beams. The optical path length difference arises from the change in refractive index but also due to the different course taken through the liquid when the angle of refraction changes with change in RI. Compared to the detection limit, a change of n₁ of order 10⁻² is large. With such large changes in refractive index one cannot ignore the change in local frequencies if one would like to infer information about these changes. One also finds that for a given value of n₁ the local frequency to a very good approximation has a linear dependency on the angular coordinate. Accordingly we can write: fₙ_{₁}(φ)≅a(n₁)φ giving:

Iₙ_{₁}(φ)≅Aₙ_{₁}(φ)sin [a(n₁)φ²+φₙ_{₁}(φ)]

This shows that if one could map the observed fringe pattern as function of φ² then for given n₁, one would obtain a fringe pattern with constant frequency.

If one instead considers a change in n₁ of order 10⁻⁶ then with such small change in the refractive index n₁ of the liquid the local frequencies practically do not change. In other words it is only the change in optical path length through the channel that causes the argument of the sinusoidal function to change. Next we have found that the local phase change actually is not constant as function of the angular observation point. But we also observe that the variation in phase change is smallest in the region closest to the zero angular coordinate, i.e. closest to the incoming beam, and we find that with a channel radius of 100 μm the deviation in phase change is around 0.2% within the first 10 degrees. If one increases the ratio between the radius of the channel and the optical wavelength by a factor of 10 (so channel radius=1 mm), the deviation in phase change is still around 0.2% within the first 10 degrees, however the actual phase change is 10 times larger for the same change in n₁. The corresponding local frequencies for this case are increased by a factor of 10 when compared to the case with the smaller channel radius.

What this shows is that there are approximately as many fringes for the latter case when observing the angular region from 0 to 1 degree as are obtained by observing the first 10 degrees of the case with the smaller radius. So by increasing the ratio of the channel radius relative to the optical wavelength one can in general obtain a given number of fringes by observing a smaller angular region. This means that the validity of assuming a constant phase change of the fringe pattern (caused by changes in n) over the considered fringe region is improved. At the same time the actual phase change also becomes larger, thereby increasing the sensitivity of the set-up.

From these simulations and observation above one can learn the following:
The fringe pattern behaves basically as a sinusoidal with constant frequency when mapped relative to the square of the angular coordinate.
For “large” changes in refractive index of the liquid the frequency of this sinusoidal pattern changes significantly.
For “small” changes in refractive index of the liquid the frequency remains constant but the fringes will shift in position due to a phase change caused by changing the optical path length for the light traversing the channel. It is a good approximation to consider this phase change to be constant over many fringes, especially when observing fringes close to the angular origin position.
From modelling work one finds that the frequency changes are governed by light refraction, which changes the angles of the rays escaping from the channel when “large” changes of n occur. Pure phase changes on the other hand are caused by changes in optical path lengths through the sample liquid. For general geometries, diffraction of light may in a similar way cause changes in the local frequencies.
By increasing the ratio of the channel radius to the optical wavelength a given number of fringes will be created within a smaller angular region making it a better approximation to consider the phase change constant over the considered fringes (the reduction in region size scales with the increase in the ratio).
By increasing the ratio of the channel radius to the optical wavelength the phase change obtained for a given change in refractive index n is increased with the same factor, implying improved sensitivity.

In the embodiment just described the chirp in the fringe pattern has been reduced by mathematical manipulation of the detected fringe spacing.

As an alternative, the observation of the chirp may be reduced or eliminated by a change in the optics of the apparatus used to capture the fringe pattern.

Where a spatially extending detector such as a CCD array 16 has been used, it has been customary to arrange it perpendicular to the direct line from the centre of the detector to the cavity 12 containing the fluid sample. We have now appreciated that the chirp previously observed in the fringe pattern on such a detector can be reduced by alternative arrangements of the detector and any intervening optics. Where the light passes directly from the scattering interfaces to the detector, the chirp may be reduced by angling the detector so that it extends at right angles to the light input direction or more preferably at an obtuse angle to it, so that the end of the detector which is nearer to the light input beam is closer to the sample position than is the other end of the detector.

This means turning the detector from the prior art position to place the direction of spatial extension of the detector perpendicular to the reverse of laser output light path or at an obtuse angle to it, whereas in said prior art position it is at an acute angle to the reverse of the light input direction.

In the embodiment shown in FIG. 3, the output light reaches the detector 20a after reflection at a beam splitter 23a. If the positions of the detector 20a and of a beam splitter 23a are as shown, the chirp produced at the detector will be reduced.

The same principle may be used in alternative optical configurations. Generally, starting from any less than optimum configuration, rotating the detector in one direction decreases the chirp effect and it is increased by rotating in the other direction

In the use of methods and apparatus according to this aspect of the invention, the detector and any associated optics may be fixed in an advantageous position or may be mounted for positional adjustment, such as detector rotation. In this latter case, a beneficial position may be experimentally determined by use of a scheme similar to that for estimating the best offset in the coordinate transformation used for the mathematical procedure in the first aspect of the invention, i.e. by picking the rotated detector/mirror position(s) that maximize(s) the peak amplitude value of the power spectrum of the recorded fringe pattern. Thus, with a known size and geometry of the channel containing the sample and a known position and direction of the incoming light beam, one can initially calculate the rotation angle giving minimum chirp or alternatively measure initially what angle gives the minimum chirp. Different detector angle may be used for each different tube diameter portion.

The first method for reducing the chirp described above is based on a remapping of the scattering/reflecting angle recorded along one camera or detector axis. This means that one also initially ideally calculates the relationship between the position of the detecting array and the scattering angle measured relative to the centroid region of the scattered/reflected beam. One might use the spatial coordinate position on the detecting array relative to the centroid of the scattered/reflected beam (the centroid position might exist outside the region covered by the detector) as an estimate of the scattering/reflected angle, even if the detecting array is not curved corresponding to an angular distribution of a circular arc defined with its center in the center of the illuminated channel containing the sample being illuminated. It is however clear that the error made by using the position on the detector as estimate of the angle, in general will only be small for sufficiently small angles around the centroid position of the generated fringe pattern. However, in this case the effect of additionally modifying the detected chirped fringe pattern by rotating the camera/detector (or equivalently a reflective element such as a beam splitter or mirror along the beam path) can reduce the error caused by the non-ideal relationship between position on the detector and the scattering/reflecting angle.

Thus, the chirp may be reduced by mathematical processing of the fringe pattern and then the angle of the detector may be varied to give lower variation in the local frequency over the considered fringe region than if the camera/detector (or a reflective element) is not rotated.

From the above discussion it is can also be seen that one could in principle compensate the chirp of the fringe pattern by using an adaptive mirror array. Such an adaptive mirror array could be made to reflect “each” ray individually in such a way that the pattern produced on the detector would be without chirp.

As an alternative to reduction of the chirp as described above, one can employ the techniques described in European Patent Application No. 1316044.1. In FIG. 1, in addition to the components already described, one may additionally use a wavelength controller 24 by means of which the wavelength of light emitted by the coherent light source 16 is swept over a range of for instance 5 nm at a sweep frequency of 16 KHz. The intensity of the light is observed at a single angle 22 from each respective input beam and the detected intensities are recorded and are analysed in computer 26. The wavelength controller 24 also provides the computer 26 with a trigger signal for the tuning range and possibly a trigger signal for linearization of the k-values obtained over the tuning range.

At any given input wavelength and any one chosen light input path/tube diameter, the scattered light forms an interference pattern within the area 18 which will have an intensity pattern of the kind shown in FIG. 2 when observed over a range of angles from the axis of the laser outwardly to one side of the input light path of the illustrated apparatus. As noted above, the interference fringes shown are not equally spaced. The figure shows intensity curves for two different refractive indices for the fluid in the sample tube, for the cases n=1.33300 and n=1.33301. It can be seen that the two curves are not readily distinguishable by position. They also have a good deal of fine structure, making the true position of each maximum difficult to identify. Thus, the fringe pattern is affected by other frequency components than the one of interest.

However, when the intensity variation with wavelength sweep is measured at a single angle of observation, a result is obtained as shown in FIG. 11, again with plots being shown for each of the two refractive index cases, n=1.333 and n=1.33301.

It is noticeable that the peaks in the illustrated plots are regularly spaced and that the peaks are less affected by other frequency components and the positions of the peaks are more clearly different for the two refractive indices.

A refractive index measurement may therefore be made by applying the usual data analysis methods employed in BSI measurements to the fringe pattern obtained by wavelength sweep.

If one records such fringe patterns as function of the inverse of the wavelength at several angular positions one could also calculate mean or median values of the individual estimates of a refractive index or refractive index change.

The interference term of interest measured with the detector as a function of the angular wavenumber k behaves like:

Intensity=sin(kΔl)

Transforming this to the usual notation for a sinusoidal form, the equation becomes:

$$I = sin ( 2 π ( \frac{Δ l}{2 π} ) k )$$

where k is the running wave-number corresponding to the swept range of the source, and Δl is the optical path length difference between the two interfering beams. If the refractive index of the liquid within the sample chamber changes Δn the interference term changes to become:

$$I = sin [ k ( Δ l + Δ nL ) ] = sin [ 2 π ( \frac{Δ l + Δ nL}{2 π} ) k ]$$

where L denotes the path length through the sample chamber experienced by only one of the interfering beams. We observe that a frequency shift of ΔnL/2π is introduced.

Because Δn for BSI could typically be in the order of 10⁻⁶ and L is in the order of 1 mm, a very large k-range would be needed to resolve the difference. Instead it is useful that due to the large values of k the frequency shift can actually be observed as a phase shift φ where:

$$sin [ k ( Δ l + Δ nL ) ] = sin [ 2 π ( \frac{Δ l + Δ nL}{2 π} ) k ] = sin [ 2 π ( \frac{Δ l}{2 π} ) k + k Δ nL ] = sin [ 2 π fk + ϕ ]$$

$$with f = \frac{Δ l}{2 π} and = k Δ nL .$$

If we sweep the wavelength through 40 nm from e.g. 1040 nm to 1080 nm, the k range corresponds to spanning from 6.0415e+006 m⁻¹ to 5.8178e+006 m⁻¹. With L=1 mm and Δn=1 E-06 this implies the “phase” φ varies from 0.0060 to 0.0058. If Δn=0.9 E-06 φ varies from 0.0054 to 0.0052.

If we sweep the wavelength through 5 nm from e.g. 1055 nm to 1060 nm, the k range corresponds to 5.96 E+06 m⁻¹ to 5.93 E+06 m⁻¹ implying that the “phase” varies from 0.0060 to 0.0059 for L=1 mm and A=1 E-06. If A=0.9 E-06 a varies from 0.0054 to 0.0053

This shows the phase change due to a change of 10 E-7 in refractive index of the liquid is around 0.0006 whereas the variation in phase due to the k variation is six times smaller for a sweep of 5 nm. Thus, if Δn=1 E-06 then by varying k by sweeping the wavelength over 5 nm varies from 0.0060 to 0.0059; a change of 0.0001. If Δn=0.9 E-6 the sweep over 5 nm makes φ vary from 0.0054 to 0.0053, again a change of 0.0001. But the change from the average of 0.006 to 0.0059 (the phase range measured with Δn=1 E-06) to the average of 0.0054 to 0.0053 (the phase range measured with Δn=0.9 E-06) is 6 times larger: 0.0006. So the variation in phase caused by the sweep over k is 6 times smaller than the overall change in phase caused by changing the refractive index by 10 E-7 (the difference between Δn=1 E-06 and Δn=0.9 E-06). This demonstrates for this exemplified case that one can interpret the essential phase change of the fringe pattern as being caused by change in refractive index (at least down to changes of 10-7). The sweep range and geometry of the channel will in general influence these numbers. The smaller the sweep range the smaller the variation in phase due to sweep.

The use of two or more path lengths through the fluid under observation allows removal of ambiguity in the k-space interference pattern in the same way as in the angular space patterns as described above.

Variations in the form of apparatus described herein may be used. For instance, rather than the sample being contained in a tubular, thin walled chamber, the sample chamber might be a cavity within a block such that the interfaces are formed only between the block material and the liquid sample where the light passes into the liquid and where the light passes out of the liquid.

As shown in FIG. 13, which is a top view of apparatus like that in FIG. 5 but with only two sample tube thicknesses, one can use a column of beam splitters positioned so that both the laser emitted light and the scattered output light pass through them. Alternatively, as in FIG. 12 one can instead use a column of mirrors 25a, 25b which interact with the laser emitted light but which are outside the observed range of angles 22 of the output light scattered from the sample tube.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference. No acknowledgement of any prior published document herein should be taken to be an admission or representation that the teaching thereof was common general knowledge in Australia or elsewhere at the date hereof.

The invention may be summarized and defined by the following clauses:
1. A method of refractive index based measurement of a property of a fluid comprising
   directing coherent light along a plurality of input light paths within an apparatus,
   for each input light path, producing scattering of said light from each of a plurality of interfaces within said apparatus including interfaces between said fluid and a surface bounding said fluid, said scattering producing an interference pattern formed by said scattered light,
   each said input light path having a path length through said fluid such that there are at least two different said path lengths and at least two different interference patterns are formed, each having a respective phase,
   recording each said different interference pattern,
   changing a refractive index determining property of said fluid and thereby changing the phase of each said interference pattern,
   calculating said change of property from said changes of phase which uniquely is consistent with each said change of phase.
2. A method as defined in clause 1, wherein light is directed along three input light paths, each having a different path length through the fluid, so producing three different interference patterns, and said calculation is based on the phases of the three interference patterns.
3. A method as defined in clause 1 or clause 2, wherein the change of said property is calculated from said changes of phase by calculating an apparent phase change of less than 2π radians between starting and changed patterns for each input path length; calculating at least two provisional values for a change in a refractive index determined property consistent with the apparent phase change observed for a first of said input path lengths, allowing that the true phase change may be greater than 2π, determining which of the determined provisional values of the change in the property is consistent with the apparent phase change calculated for a second, shorter light input path length; and choosing that consistent provisional value as the true changed value of the change in the property.
4. A method as defined in clause 1 or clause 2, wherein the change of said property is calculated from said changes of phase by
   determining an integer value N such that:
   ABS((N*2π+Δφ₂)/s_{higher}−Δφ₁/s_{lowest}) is minimized, where Δφ₁ denotes the observed phase change produced by the shortest of the light paths, Δφ₂ denotes the observed phase change corresponding to a longer one of said light paths, S for each light path is the sensitivity of the measurement for that light path dφ/dn, so that s_{lowest}=(dφ/dn)_{lowest}, and s_{higher}=(dφ/dn)_{higher}, and
   forming a revised estimate of the actual phase change for the longer light path according to the formula N*2π+Δφ₂.
5. A method as defined in any preceding clause, wherein for each light path length
   a varying intensity of light in said pattern is detected in a spatially extending detector crossing the pattern,
   said detected intensity of light for each light path comprises alternating light and dark fringes spaced one from another on at least one side of a centroid position, and in the interference pattern, optionally after mathematical transformation, a figure of merit (M) measured over n fringes contained within the first 15 fringes starting from the centroid position is not greater than 0.005, where n is 10,
   M being calculated according to the formula:

M=standard deviation of fringe spacing/(mean spacing of fringes*number of fringes(n)).
6. A method as defined in any one of clauses 1-4, wherein
   for each input light path there is produced an interference pattern formed by said scattered light and for each light path varying intensity of light in said pattern is recorded in a spatially extending detector crossing fringes of said interference pattern,
   said recorded varying intensity of light in said pattern is mathematically transformed to reduce or remove a chirp in a local spatial frequency of fringes exhibited by said pattern at the detector and thereby a modified intensity variation is produced and said calculation of the change of property is performed based on the phase changes of said modified intensity variations.
7. A method as defined in clause 6, wherein said recorded intensity of light comprises alternating light and dark fringes spaced one from another on at least one side of a centroid position, and in the interference pattern, after said mathematical transformation, a figure of merit (M) measured over n fringes contained within the first 15 fringes starting from the centroid position is not greater than 0.005, where n is 10, M being calculated according to the formula:

M=standard deviation of fringe spacing/(mean spacing of fringes*number of fringes(n)).
8. A method as defined in any one of clauses 5 to 7, wherein said mathematically transforming step is conducted by applying a coordinate transformation to said recorded varying intensity of light along the detector.
9. A method as defined in clause 8, wherein a spectrum of spatial frequencies is obtained for the said recorded intensity, a maximum peak amplitude value of said spectrum of spatial frequencies is determined, a first offset value (x_{offset}) is chosen by which to transform a coordinate (x) of intensity values in said recorded varying intensity of light along the detector and said coordinate transformation is carried out using said first offset value, the spectrum of spatial frequencies and the peak amplitude value thereof are obtained again and compared with their previous values and the process is repeated using different offset values to obtain a value of the offset value that increases the maximum peak amplitude value.
10. A method as defined in any one of clauses 5-9, wherein the detector and any optics intervening between the detector and the said interfaces are so arranged that said chirp in the local spatial frequency at the detector prior to said mathematical transformation is no greater than would be observed if the intensity of light following said output paths was recorded on a detector extending orthogonally to said input light path without any optics intervening between the said detector and said interfaces.
11. A method as defined in clause 10, wherein a spectrum of spatial frequencies is obtained for the said recorded intensity, the arrangement of the detector and any optics intervening between the detector and the said interfaces is adjusted, the spectrum of spatial frequencies and the peak amplitude value thereof are obtained again and compared with their previous values and the process is repeated to obtain a said arrangement that increases the maximum peak amplitude value.
12. A method as defined in clause 11, wherein an offset value is selected that provides the maximum value obtained for the maximum peak amplitude value.
13. A method as defined in clause 12, wherein the adjustment of said arrangement of the detector and any optics intervening between the detector and the said interfaces is a rotation of the detector or a rotation of a reflective optical component intervening between the detector and said interfaces.
14. A method as defined in any one of clauses 1-4, further comprising for each input light path obtaining the respective interference patterns by varying the wavelength of said light in said input light path and recording variation of intensity of the interfering light with change in wavelength of the light at an angle of observation.
15. A method as defined in clause 14, wherein said varying of the wavelength of said light in each light input path sweeps the wavelength of the light over a range of wavelengths, which range is from 1 nm to 20 nm wide.
16. A method as defined in clause 14 or clause 15, wherein the varying of the wavelength of the light is repeated cyclically.
17. A method as defined in clause 16, wherein said varying of the wavelength of said light sweeps the wavelength of the light cyclically at a rate of from 10 Hz to 50 KHz.
18. A method as defined in any preceding clause, wherein said apparatus includes a flow path for the supply of a fluid to a location where the fluid meets the input light paths and a flow path for removal of said fluid from said location.
19. A method as defined in clause 18, further comprising the step of driving a flow of fluid through said location.
20. A method as defined in any preceding clause, further comprising operating a temperature control means to maintain said fluid at a desired constant or varying temperature.
21. A method as defined in any preceding clause, wherein each interference pattern is detected at a position where it is formed by backscattered light.
22. Apparatus for use in performing a refractive index based measurement of a change in a property of a fluid, by a method comprising directing coherent light along input light paths within said apparatus, producing scattering of said light from each of a plurality of interfaces within said apparatus including interfaces between said fluid and a surface bounding said fluid, and for each input light path detecting properties of an interference pattern formed by said scattered light,
   wherein said apparatus comprises
   at least one source of coherent light for directing light along at least two said input light paths,
   a cavity in each input light path for containing said fluid in use and defining said plurality of interfaces, each cavity defining a path length in said fluid for light in a respective said input light path, such that the path lengths defined by the respective cavities differ from one another,
   at least one detector positioned to sense light forming at least two said interference patterns of fringes produced by scattering from said interfaces in respective ones of said at least two input light paths in use, said detector producing in use an electronic output in response thereto which provides a recording of varying intensity of light in each of said interference patterns, and
   computation means for extracting from a shift in position of fringes in each of said at least two interference fringe patterns a calculated change in said property which uniquely is consistent with the shift measured in each said interference fringe pattern.
23. Apparatus as defined in clause 22, wherein said cavities for containing said fluid are portions of a tube, said portions having differing respective dimensions in a transverse direction along which said light passes in use.
24. Apparatus as defined in clause 23, wherein said tube is a stepped diameter circular cross sectioned tube.
25. Apparatus as defined in any one of clauses 22 to 24, comprising at least two said coherent light sources, each said light source being arranged to direct light along a respective one of said light input paths.
26. Apparatus as defined in any one of clauses 22 to 24, comprising one coherent light source and at least one optical component for splitting the light output of said source to pass along multiple said light input paths.
27. Apparatus as defined in any one of clauses 22 to 26, comprising a respective said detector for sensing light forming each of said interference fringe patterns.
28. Apparatus as defined in any one of clauses 22 to 27, wherein the path lengths defined by the respective cavities differ from one another by a factor of other than 2.
29. Apparatus as defined in any one of clauses 22 to 28, comprising three said cavities defining different respective path lengths, such that the largest path length differs from the middle path length by a factor different from the factor by which the middle path length differs from the smallest path length.
30. Apparatus as defined in any one of clauses 22 to 29, wherein said computation means is pre-programmed to remove or reduce a chirp exhibited by a spatial frequency of fringes in each said interference fringe pattern by a method comprising mathematically transforming a recorded varying intensity of light in said pattern to reduce or remove said chirp prior to extracting said change of property.
31. Apparatus as defined in any one of clauses 22 to 29, wherein the or each coherent light source is a variable wavelength coherent light source, and the apparatus further comprises a wavelength controller operable for varying the wavelength of said light in each said input light path so as to produce a variation at an angle of observation of intensity of detected interfering light with change in wavelength of the light, and the computation apparatus is programmed for calculating said fringe position shift from said variation for each cavity prior to extracting said change of property.
32. Apparatus as defined in any one of clauses 22 to 31, wherein each said cavity has a transverse dimension in the direction of its input light path of from 1 μm to 10 mm.
33. Apparatus as defined in clause 32, wherein each said cavity has a transverse dimension in the direction of its input light path of from 0.5 to 3 mm.
34. Apparatus as defined in any one of clauses 22 to 33, wherein said apparatus includes a flow path for the supply of a fluid to an upstream one of said cavities and a flow path for removal of said fluid from a downstream one of said cavities which is in fluid communication with said upstream cavity.
35. Apparatus as defined in clause 34, further comprising means for driving a flow of fluid through said cavities.
36. Apparatus as defined in any one of clauses 22 to 35, further comprising a temperature control for maintaining said fluid at a desired constant or variable temperature.

1. A method of refractive index based measurement of a property of a fluid comprising:
directing coherent light along a plurality of input light paths within an apparatus,
for each input light path, producing scattering of said light from each of a plurality of interfaces within said apparatus including interfaces between said fluid and a surface bounding said fluid, said scattering producing an interference pattern formed by said scattered light,
each said input light path having a path length through said fluid such that there are at least two different said path lengths and at least two different interference patterns are formed, each having a respective phase,
recording each said different interference pattern,
changing a refractive index determining property of said fluid and thereby changing the phase of each said interference pattern,
calculating said change of property from said changes of phase which uniquely is consistent with each said change of phase.

2. A method as claimed in claim 1, wherein light is directed along three input light paths, each having a different path length through the fluid, so producing three different interference patterns, and said calculation is based on the phases of the three interference patterns.

3. A method as claimed in claim 1, wherein the change of said property is calculated from said changes of phase by calculating an apparent phase change of less than 2π radians between starting and changed patterns for each input path length; calculating at least two provisional values for a change in a refractive index determined property consistent with the apparent phase change observed for a first of said input path lengths, allowing that the true phase change may be greater than 2π, determining which of the determined provisional values of the change in the property is consistent with the apparent phase change calculated for a second, shorter light input path length; and choosing that consistent provisional value as the true changed value of the change in the property.

4. A method as claimed in claim 1, wherein the change of said property is calculated from said changes of phase by
determining an integer value N such that:
ABS((N*2π+Δφ₂)/s_{higher}−Δφ₁/s_{lowest}) is minimized, where Δφ₁ denotes the observed phase change produced by the shortest of the light paths, Δφ₂ denotes the observed phase change corresponding to a longer one of said light paths, S for each light path is the sensitivity of the measurement for that light path dφ/dn, so that s_{lowest}=(dφ/dn)_{lowest}, and s_{higher}=(dφ/dn)_{higher}, and
forming a revised estimate of the actual phase change for the longer light path according in g to the formula N*2π+Δφ₂.

5. A method as claimed in claim 1, wherein
for each input light path there is produced an interference pattern formed by said scattered light and for each light path varying intensity of light in said pattern is recorded in a spatially extending detector crossing fringes of said interference pattern,
said recorded varying intensity of light in said pattern is mathematically transformed to reduce or remove a chirp in a local spatial frequency of fringes exhibited by said pattern at the detector and thereby a modified intensity variation is produced and said calculation of the change of property is performed based on the phase changes of said modified intensity variations.

6. A method as claimed in claim 1, further comprising for each input light path obtaining the respective interference patterns by varying the wavelength of said light in said input light path and recording variation of intensity of the interfering light with change in wavelength of the light at an angle of observation.

7. A method as claimed in claim 1, further comprising operating a temperature control means to maintain said fluid at a desired constant or varying temperature.

8. A method as claimed in claim 1, wherein each interference pattern is detected at a position where it is formed by backscattered light.

9. Apparatus for use in performing a refractive index based measurement of a change in a property of a fluid, by a method comprising directing coherent light along input light paths within said apparatus, producing scattering of said light from each of a plurality of interfaces within said apparatus including interfaces between said fluid and a surface bounding said fluid, and for each input light path detecting properties of an interference pattern formed by said scattered light,
wherein said apparatus comprises:
at least one source of coherent light for directing light along at least two said input light paths,
a cavity in each input light path for containing said fluid in use and defining said plurality of interfaces, each cavity defining a path length in said fluid for light in a respective said input light path, such that the path lengths defined by the respective cavities differ from one another,
at least one detector positioned to sense light forming at least two said interference patterns of fringes produced by scattering from said interfaces in respective ones of said at least two input light paths in use, said detector producing in use an electronic output in response thereto which provides a recording of varying intensity of light in each of said interference patterns, and
computation means for extracting from a shift in position of fringes in each of said at least two interference fringe patterns a calculated change in said property which uniquely is consistent with the shift measured in each said interference fringe pattern.

10. Apparatus as claimed in claim 9, wherein said cavities for containing said fluid are portions of a tube, said portions having differing respective dimensions in a transverse direction along which said light passes in use.

11. Apparatus as claimed in claim 9, wherein the path lengths defined by the respective cavities differ from one another by a factor of other than 2.

12. Apparatus as claimed in claim 9, comprising three said cavities defining different respective path lengths, such that the largest path length differs from the middle path length by a factor different from the factor by which the middle path length differs from the smallest path length.

13. Apparatus as claimed in claim 9, wherein said computation means is pre-programmed to remove or reduce a chirp exhibited by a spatial frequency of fringes in each said interference fringe pattern by a method comprising mathematically transforming a recorded varying intensity of light in said pattern to reduce or remove said chirp prior to extracting said change of property.

14. Apparatus as claimed in claim 9, wherein the or each coherent light source is a variable wavelength coherent light source, and the apparatus further comprises a wavelength controller operable for varying the wavelength of said light in each said input light path so as to produce a variation at an angle of observation of intensity of detected interfering light with change in wavelength of the light, and the computation apparatus is programmed for calculating said fringe position shift from said variation for each cavity prior to extracting said change of property.

15. Apparatus as claimed in claim 9, wherein each said cavity has a transverse dimension in the direction of its input light path of from 0.5 to 3 mm.
